(19) United States
(12) Patent Application Publication
(10) Pub. No.: US 2016/0118160 A1
(43) Pub. Date: Apr. 28, 2016

(54) Wire Structure Improvement

(71) Applicant: VSO ELECTRONICS CO., LTD., New Taipei City (TW)

(72) Inventors: Ming-Han Perng, New Taipei City (TW); Chung-Cheng Chien, New Taipei City (TW)

(21) Appl. No.: 14/523,951

(22) Filed: Oct. 27, 2014

(51) Int. Cl. H01B 7/08; H01B 7/00

(52) U.S. Cl. CPC H01B 7/0838; H01B 7/0045

(57) ABSTRACT

A wire structure improvement comprises a first ground layer on which a first insulation layer is placed and plural transmission conductors and plural ground conductors are orderly arranged in the first insulator next to the first ground layer. A second insulation layer is disposed on the transmission conductors and the ground conductors opposite to the first insulation layer, and a second ground layer is disposed on the second insulator. The first ground layer and the second ground layer are interconnected through the ground conductors. In general, the structure improvement of the wire features cost down, boosting production pace and transmission rate and diminishing electromagnetic interference, radio interference and common mode impedance.

### TECHNICAL FIELD OF THE INVENTION

The present invention generally relates to a wire, and more particularly to structure improvement of the wire that features cost down, boosting production pace and transmission rate and diminishing electromagnetic interference, radio interference and common mode impedance.

### DESCRIPTION OF THE PRIOR ART

With reference to FIG. 1, FIG. 1 is a schematic diagram of the implementation of a convectional core-spun bus line. As shown clearly in the diagram, the bus line includes plural paralleled conductive wires 91. The conductive wires 91 each is encircled by a first insulator 92 to constitute a transmission line, and the transmission lines each is adjacent to plural ground wires 93 arranged in order, where the conductive wires 91 and the ground wires 93 are disposed separately yet wrapped together by a metal layer 94 in groups, to attenuate interference for the transmission lines, followed by a second insulator 95 to wrap all metal layers 94 to form the conventional core-spun bus line. However, the multilayer-wrapping structure of the conventional core-spun bus line leads to prolonged production and high cost. And measurements also show its capacity to resist against electromagnetic interference and radio interference is still insufficient.

### SUMMARY OF THE INVENTION

An object of the present invention lies in: diminishing production cost and boosting production pace.

Another object of the present invention lies in: attenuating electromagnetic interference, radio interference and common mode impedance.

The foregoing objects are achieved in accordance with the present invention which comprises a first ground layer on which a first insulation layer is placed and plural transmission conductors and plural ground conductors are orderly arranged in the side of the first insulator opposite to the first ground layer, where the transmission conductors each and the ground conductors each are separated in a constant distance one with the other. A second insulation layer is disposed on the side of the transmission conductors and the ground conductors opposite to the first insulation layer, and a second ground layer is disposed on the second insulator opposite to the transmission conductors and the ground conductors, where the second ground layer and the first ground layer are interconnected by the ground conductors. Accordingly, the layered structure enables the production simpler, faster and cost down. The transmission conductors that come with the electric current flow will produce electromagnetic interference, radio interference and common mode impedance. With the support of the ground conductors, the first ground layer and the second ground layer, the effect by the above impeding matters can be substantially attenuated by way of blocking and guiding, and as a result, the transmission rate of the transmission conductors is lifted. With the aid of the above techniques, the existing drawbacks for the core-spun bus line such as prolonged production, high cost, and the deficiency on resisting against electromagnetic interference and radio interference could be substantially intensified, which achieves cost down and boosting production pace and transmission rate; meanwhile, enhancing inventiveness through attenuating electromagnetic interference, radio interference and common mode impedance.

### BRIEF DESCRIPTION OF THE DRAWINGS

FIG. 1 is a schematic diagram of the implementation of a conventional core-spun bus line;

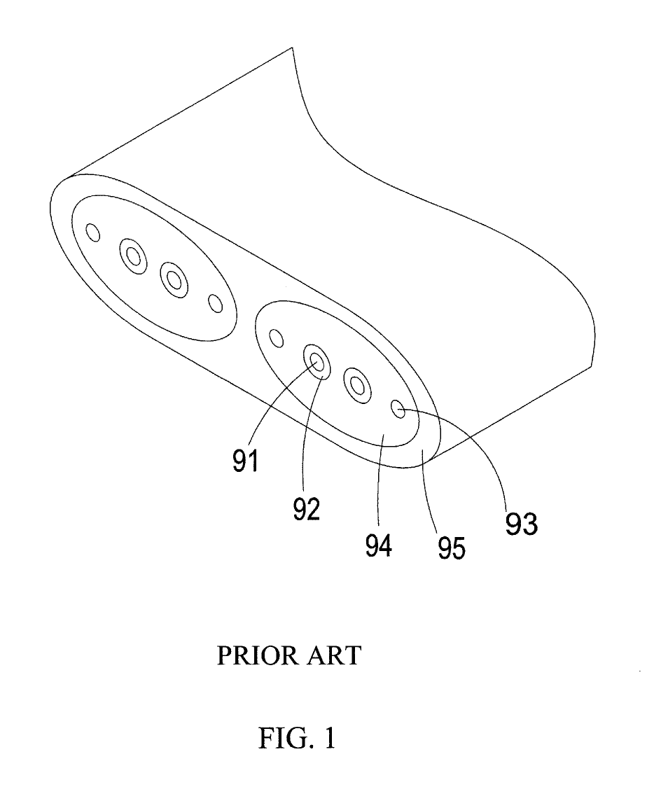

FIG. 2 is a schematic diagram of the implementation according to the first preferred embodiment of the present invention; and

FIG. 3 is a schematic diagram of the implementation according to the second preferred embodiment of the present invention.

### DETAILED DESCRIPTION OF THE PREFERRED EMBODIMENTS

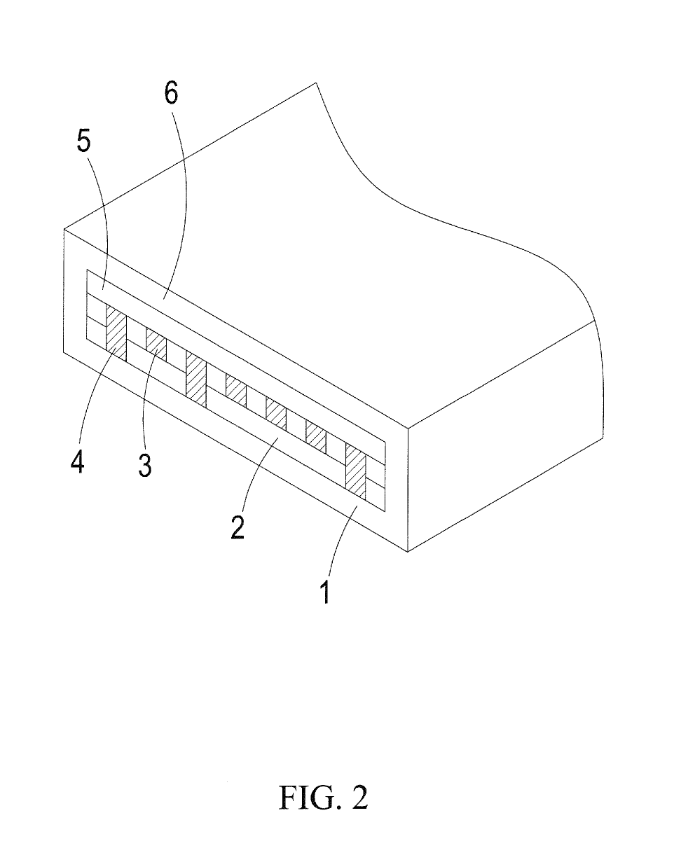

With reference to FIG. 2, FIG. 2 is a schematic diagram of the implementation according to the first preferred embodiment of the present invention. The diagram depicts distinctly that the present invention comprises a first ground layer 1, a first insulation layer 2, plural transmission conductors 3, plural ground conductors 4, a second insulation layer 5 and a second ground layer 6, wherein the first ground layer 1, the plural transmission conductors 3, the plural ground conductors 4 and the second ground layer 6 contain metal substance. More specifically, the first ground layer 1 and the second ground layer 6 contain aluminum substance, and the transmission conductors 3 and ground conductors 4 contain copper substance. Moreover, the first insulation layer 2 and the second insulation layer 5 contain insulation substance.

As for the relative positions of the structure of the present invention, the first insulation layer 2 is disposed on top of the first ground layer 1, and the plural transmission conductors 3 are orderly arranged in the side of the first insulation layer 2 opposite to the first ground layer 1 while the ground conductors 4 are arrayed in the first insulation layer 2 next to the first ground layer 1. The ground conductors 4 and the transmission conductors 3 are arranged orderly one with the other, and the second insulation layer 5 is disposed on the transmission conductors 3 and the ground conductors 4 opposite to the first insulation layer 2, and the second ground layer 6 is disposed on the second insulation layer 5 opposite to the transmission conductors 3 and the ground conductors 4, where the first ground layer 1 and the second ground layer 6 are interconnected by the ground conductors 4.

A further description on the relative linking relations of the structure of the present embodiment is given herein, where the first ground layer 1 and the second ground layer 6 are connected for conduction purpose, and cooperate to wrap the first insulation layer 2, the transmission conductors 3, the ground conductors 4 and the second insulation layer 5. The ground conductors 4 penetrate through the first insulation layer 2 and connect directly with the first ground layer 1 for the conduction, and it means the ground conductors 4 is thus connected to the second ground layer 6 indirectly.

Because the layered structure is employed in the production of the present invention to replace the conventional core-spun bus line, it enables the production simpler, faster and cost down. The electromagnetic interference, radio interference and common mode impedance occurred due to the activation of the transmission conductors 3 and the surrounding electronic parts can be substantially attenuated by way of blocking and guiding through the cooperation among the ground conductors 4, the first insulation layer 2 and the second insulation layer 5, which substantially lowers the impact to the transmission conductors 3 and boosting transmission rate of the transmission conductors 3.

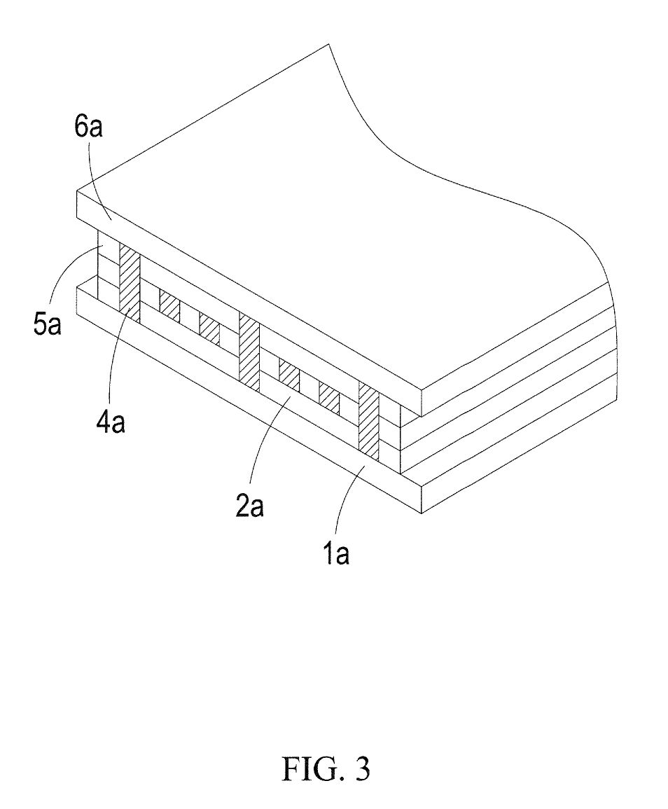

With reference to FIG. 3, FIG. 3 is a schematic diagram of the implementation according to the second preferred embodiment of the present invention. It is clear from the figure that the relative positions of the structure of the present embodiment are mostly identical to the foregoing embodiment. And the differentiation between the two embodiments lies in their relative linking relation respectively. The ground conductors 4a of the present embodiment penetrate through the first insulation layer 2a and the second insulation layer 5a and connect directly with the first ground layer la and the second ground layer 6a for conduction purpose, which illustrates that the present invention can be realized through different embodiments.

Accordingly, the characteristics of the improvement of the wire structure of the present invention that can improve the techniques of the prior art lie in:

With the cooperation of the first ground layer 1, the ground conductors 4 and the second ground layer 6, the inventiveness of the present invention such as lifting transmission rate and attenuating electromagnetic interference, radio interference and common mode impedance can be achieved.

With the cooperation of the first ground layer 1, the first insulation layer 2, the transmission conductors 3, the ground conductors 4, the second insulation layer 5 and the second ground layer 6, the inventiveness of the present invention such as lowing cost and boosting production pace can be achieved.

1. A wire structure improvement, comprising:
a first ground layer;
a first insulation layer, mounted on said first ground layer and having a top surface that is distant from said first ground layer;
a plurality of transmission conductors, where said transmission conductors are formed on the top surface of the said first group layer and located on a side of said first insulation layer opposite to said first ground layer;
a plurality of ground conductors, where said ground conductors are arrayed in the side of said first insulation layer opposite to said first ground layer, said ground conductors and said transmission conductors are aligned one with the other, and said ground conductors are conductively connected with said first ground layer;
a second insulation layer, mounted on a side of said transmission conductors and said ground conductors opposite to said first insulation layer; and
a second ground layer, mounted on a side of said second insulation layer opposite to said transmission conductors and said ground conductors, and said second ground layer being conductively connected with said ground conductors.

2. The wire structure improvement as recited in claim 1, wherein said ground conductors each penetrates through said first insulation layer and is conductively connected directly with said first ground layer.

3. The wire structure improvement as recited in claim 2, wherein said first ground layer is conductively connected with said second ground layer.

4. The wire structure improvement as recited in claim 3, wherein said first ground layer and said second ground layer cooperate to wrap said first insulation layer, said transmission conductors, said ground conductors and said second insulation layer.

5. The wire structure improvement as recited in claim 1, wherein said ground conductors penetrate through said first insulation layer and said second insulation layer and are conductively connected with said first ground layer and said second ground layer.

6. The wire structure improvement as recited in claim 1, wherein said first ground layer, said plurality of transmission conductors, said plurality of ground conductors and said second ground layer comprise metal substance.

7. The wire structure improvement as recited in claim 6, wherein said first ground layer and said second ground layer comprise aluminum substance.

8. The wire structure improvement as recited in claim 6, wherein said transmission conductors and said ground conductors comprise copper substance.

9. The wire structure improvement as recited in claim 1, wherein said first insulation layer and said second insulation layer comprise insulation substance.
